(19) United States
(12) Patent Application Publication
(10) Pub. No.: US 2015/0359195 A1
(43) Pub. Date: Dec. 17, 2015

(54) Pet Toy and Feeder

(71) Applicant: Zigoo LLC, West Chester, OH (US)

(72) Inventor: Stephen Day, Cincinnati, OH (US)

(21) Appl. No.: 14/741,434

(22) Filed: Jun. 16, 2015

Related U.S. Application Data
(60) Provisional application No. 62/013,067, filed on Jun. 17, 2014.

(51) Int. Cl. A01K 15/02

(52) U.S. Cl. CPC A01K 15/025

(57) ABSTRACT

A pet toy and feeder includes a main container, an insert, a lid, a ring, and an optional jar. In an example configuration the main container holds the jar, and the insert is placed within the jar. The lid attaches to the main container and the ring connects around the outside of the main container such that the pet toy and feeder is in an assembled state. In another example configuration the jar replaces the main container with the lid and the ring connecting to the jar. In use the inserts collects portions of a food item, e.g. peanut butter, within the main container or jar. The ring tilts the orientation of the pet toy and feeder such that the insert is accessible to a pet via one or more openings in an end of the pet toy and feeder.

### PRIORITY

This application claims priority to U.S. Provisional Patent Application Ser. No. 62/013,067, filed Jun. 17, 2014, entitled “Pet Toy & Feeder,” the disclosure of which is incorporated by reference herein.

### BACKGROUND

A wide variety of pet toys exist in the marketplace. Some comprise an object to chew, or an object to throw and retrieve, or an object that makes noise, or an object that is visually of interest to the pet, among other things. While a variety of pet toys have been made and used, it is believed that no one prior to the inventor(s) has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements. The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

FIG. 1 depicts a perspective view of an exemplary pet toy and feeder.

FIG. 2 depicts a side view of the pet toy of FIG. 1 shown with the pet toy of FIG. 1 lying on its side.

FIG. 3 depicts an exploded view of the pet toy of FIG. 1 shown with a ring of the pet toy in cross section, and also shown in an alternate configuration with an exemplary optional jar added that can be used with the pet toy.

FIG. 4 depicts an exploded view of the pet toy of FIG. 1 in an alternate configuration with the exemplary jar of FIG. 3 replacing the main container.

### DETAILED DESCRIPTION

The following description of certain examples of the invention should not be used to limit the scope of the present invention. Other examples, features, aspects, embodiments, and advantages of the invention will become apparent to those skilled in the art from the following description. As will be realized, the invention is capable of other different aspects, all without departing from the invention. Accordingly, the drawings and descriptions should be regarded as illustrative in nature and not restrictive.

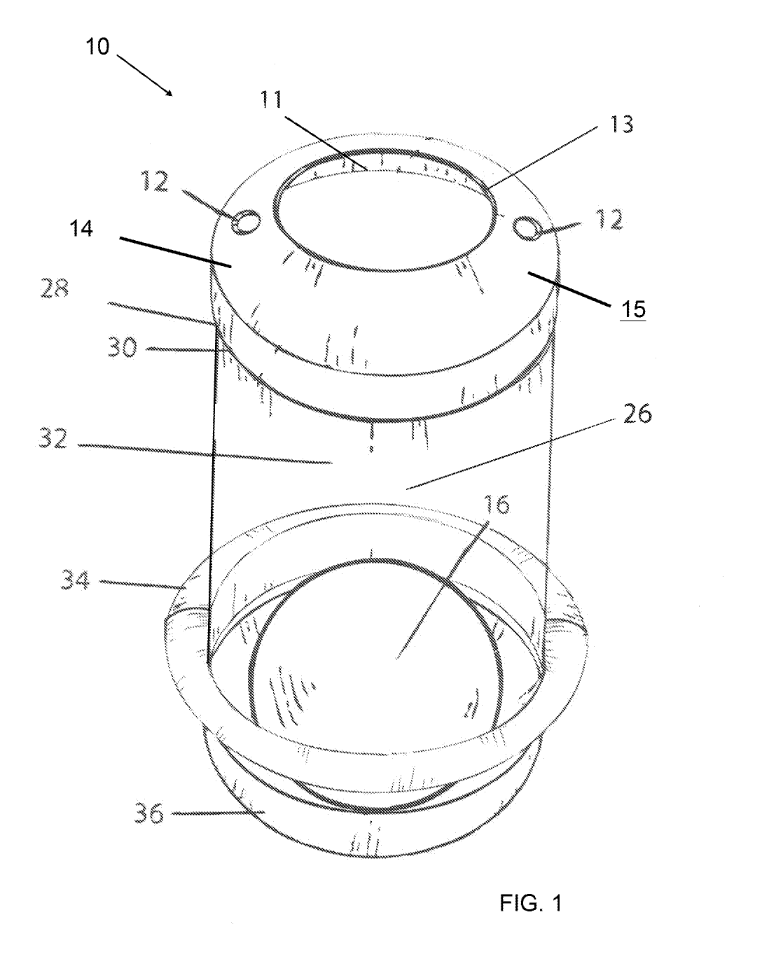

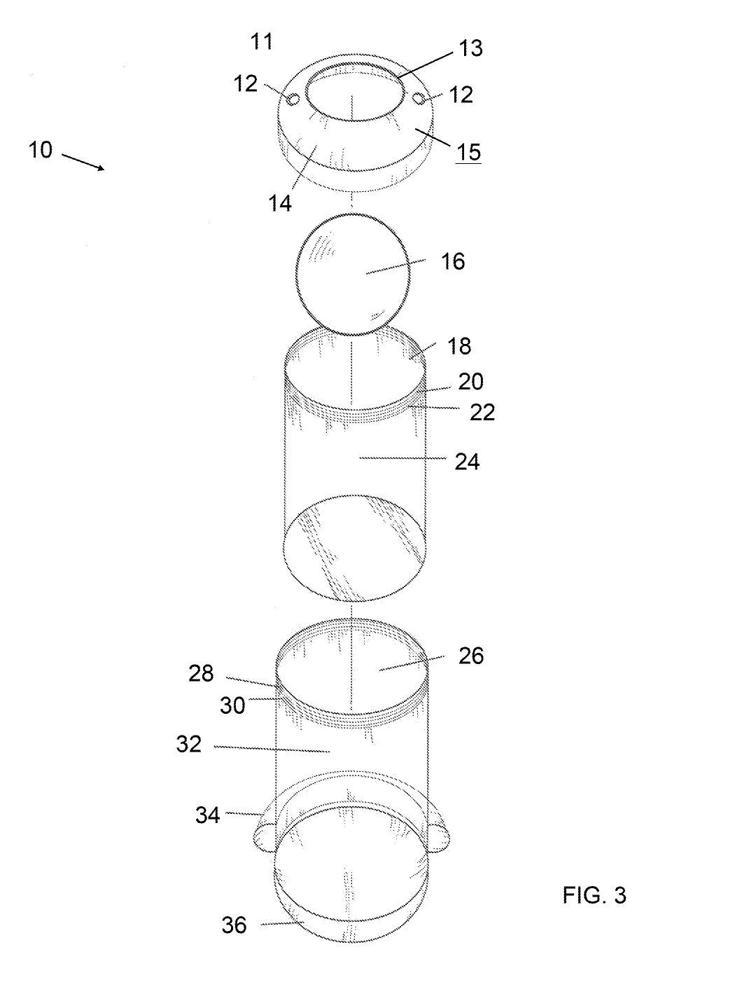

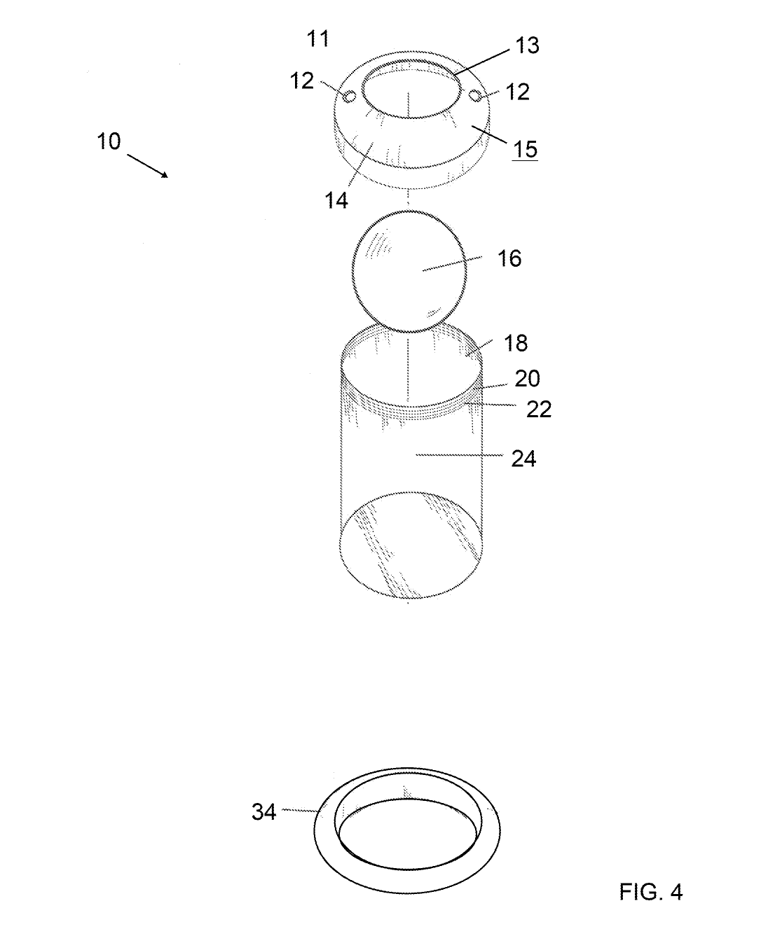

FIGS. 1-4 illustrate an exemplary pet toy and feeder (10) with FIGS. 3 and 4 showing alternative configurations for the pet toy and feeder (10). Pet toy and feeder (10) may be referred to as pet toy (10), feeder (10), and/or apparatus (10). In some versions pet toy and feeder (10) is used as a toy and feeder for a pet such as a dog for instance, while in other versions pet toy and feeder (10) can be used as a toy and feeder for another type of pet. In use as a feeder, pet toy and feeder (10) can dispense food items or portions of a food item to a pet during the pet's interaction with the pet toy and feeder (10). It should be noted that pet toy and feeder (10) is not required to be used with a food item and in some instances can be used without a food item and function as only a pet toy.

Pet toy and feeder (10) comprises a generally cylindrical shape in the illustrated version with pet toy and feeder (10) comprising a lid (14), a main container (32), and an insert (16). The lid (14) comprises a first opening (13), one or more second openings (12), and a third opening (11). The insert (16) comprises an outer surface and is configured to be placed into the main container (32). However, in some other versions, as will be described further below, the insert (16) may be positioned within a different jar or container (24) as shown in FIGS. 3 and 4, e.g. a peanut butter jar or other food related jar, which may be used as an additional optional component of the pet toy and feeder (10) where the jar (24) is positionable within the main container (32). Still yet in some versions the jar (24) may be used instead of the main container (32) as opposed to in addition to the main container (32). It should be noted herein that the terms “jar,” “container,” and “main container” can be used interchangeably such that main container (32) can also be considered jar (32) or simply container (32). Similarly jar (24) can also be considered container (24).

Returning to the illustrated example in FIG. 1, the lid (14) connects with the main container (32) to keep the insert (16) within the main container (32). In such versions where the jar (24) may be used instead of the main container (32), the lid (14) can be configured to attach securely to the jar (24). The diameter and other parameters of the lid (14) can vary to fit the different versions or sizes of the main container (32) or the jar (24). For instance, the size of the third opening (11) and the arrangement of any threaded portions of the lid (14), or snap-on features of the lid (14), may change with various lids (14) to accommodate screwing, snapping-on, or otherwise attaching the lid (14) onto main containers (32) or jars (24) of various sized pet toy and feeders (10).

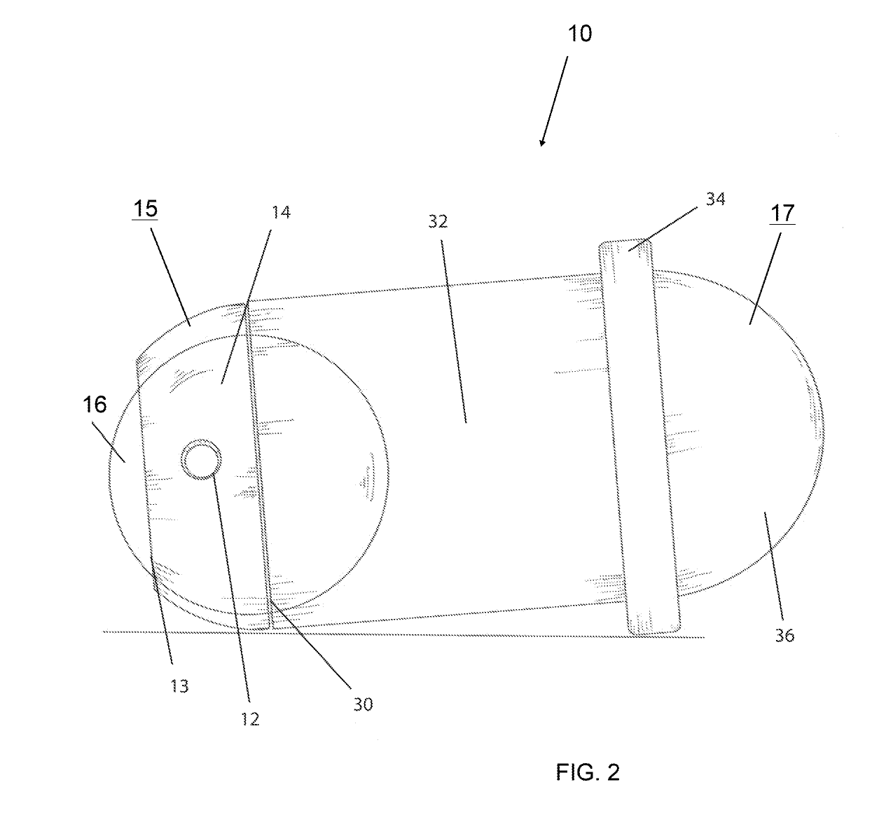

The pet toy and feeder (10) further comprises a projecting member, which in the present example is in the form of a ring (34) on the outside of the main container (32). The ring (34) is configured and positioned relative to the main container (32) such that when the pet toy and feeder (10) is on its side (as shown in FIG. 2), the pet toy and feeder (10) assumes a tilted orientation that keeps the insert (16) close to or toward the first opening (13) in the lid (14). For instance, this can be achieved by the ring (34) having a larger outer diameter than the main container (32) to which the ring (34) attaches to. For instance, in one version the outer diameter of the main container (32) and lid (14) is about 3.5 inches, while the outer diameter of the ring (34) is about 4.0 inches. With the ring (34) positioned around the main container (32), because of its position and its larger outer diameter, the pet toy and feeder (10) will adopt a tilted or angled orientation when positioned or lying on its side as shown in FIG. 2. Where the jar (24) is used instead of the main container (32), the ring (34) can be positioned on the outside of the jar (24) and function similarly as described above with respect to the main container (32).

While the present example shows the projecting member as the ring (34), in other versions the projecting member can take other forms than a ring, e.g. a plurality of spikes or other projections extending around the outer perimeter of the main container (32) or jar (24) depending on the configuration of the pet toy and feeder (10) being used. In view of the teachings herein other projecting members and ways to guide the insert (16) toward the first opening (13) will be apparent to those of ordinary skill in the art. For instance, the main container (32) in some versions can include a guide element or guiding feature to bias or direct the insert (16) toward the first opening (13). By way of example only, and not limitation, the container (32) may have a shape that directs the inset (16) toward the first opening (13). In such an example, an interior wall of the container (32) may be sloped toward the first opening (13) such that the insert (16) would travel toward the first opening (13) under the force of gravity. In some instances the projecting member, in the forms of the ring (34) or otherwise, can be considered a guide element or guiding feature.

As mentioned above, the lid (14) comprises the first opening (13), one or more second openings (12), and the third opening (11). The first opening (13), in the present example, is circular in shape. In other versions, other shapes for the first opening (13) can be used, and such other shapes will be apparent to one of ordinary skill in the art in view of the teachings herein. The first opening (13) provides access to an interior space (26) of the main container (32), and/or where jar (24) is used to an interior space (18) of the jar (24). The first opening (13) is configured to prevent or inhibit the insert (16) from easily falling out of, or becoming separated from, the main container (32) or the jar (24) when present. For instance, in some versions the first opening (13) is configured with a diameter that is smaller than the widest diameter of the insert (16). Furthermore, the insert (16) in the present example is spherical in shape such that a portion of the insert (16) is able to protrude or stick out from the first opening (13) in the lid (14). For instance, in one version, the diameter of the first opening (13) is about 2.3 inches and the widest diameter of the insert (16) is about 3.0 inches. Thus in some versions, the first opening (13) allows for enough of the insert (16) to protrude from the first opening (13) such that the insert (16) may be licked by the pet, but not enough of the insert (16) protrudes from the first opening (13) to allow the pet to chew the insert (16).

In the present example, the first opening (13) is raised or spaced from the third opening (11) by about 1.5 inches. In some other versions, the first opening (13) can be raised or spaced more or less than 1.5 inches from the third opening (11). The lid (14) further comprises a smooth outer surface in some versions, while in other versions the lid (14) can include various textures for the outer surface of the lid (14). The types and degree of textures for the lid (14) will be apparent to one of ordinary skill in the art in view of the teachings herein. The lid (14) in the illustrated version also comprises a curved top surface (15) that defines a portion of the lid (14) between the first and third openings (13, 11).

One or more second openings (12) are located on the top of the lid (14). The second opening (12) provides another access point to the interior space (26) of the main container (32) and/or to the interior space (18) of the jar (24) as the case may be depending on the configuration of the pet toy and feeder (10). This access to the interior space can allow for air to get within the main container (32) and/or jar (24). The second opening (12), in the present example, has a circular shape with a diameter of about 0.25 inches. In other versions, other shapes and sizes for the second opening (12) can be used, e.g. triangular, square, and other shapes that will be apparent to one of ordinary skill in the art in view of the teachings herein. In the illustrated example of FIG. 1, the second opening (12) is about 1.5 inches away from the third opening (11), although this is not a required distance. Also in the illustrated version there are two second openings (12). In some other versions there may be more or less than two second openings (12), or in some cases the second openings (12) can be omitted.

The third opening (11) of the lid (14) is configured to selectively and securely attach the lid (14) to the main container (32) or jar (24) depending on the configuration of the pet toy and feeder (10). In the present example, the lid (14) screws tightly onto the main container (32) or jar (24) such that the lid (14) is configured with a threaded portion near the third opening (11), and this threaded portion threadably engages with a threaded portion on the main container (32) or jar (24). In other versions, other ways to connect the lid (14) with the main container (32) or jar (24) can be used and will be apparent to one of ordinary skill in the art in view of the teachings herein.

In the present example, the main container (32) comprises an outer wall defining an outer surface and perimeter of the main container (32). The main container (32) further comprises a bottom (36) that has a rounded or curved surface (17). However, in some other versions the bottom (36) can have different shapes, and any such shapes will be apparent to one of ordinary skill in the art in view of the teachings herein. In use, the rounded or curved bottom (36) of the main container (32) prevents the pet toy and feeder (10) from having a vertical orientation where the lid (14) would be at the top and the insert (16) would fall to the bottom because of gravity. Instead, the curved or rounded bottom (36) promotes the pet toy and feeder (10) to adopt a position where the pet toy and feeder (10) lies on its side as shown in FIG. 2. As discussed above, this promotes the insert (16) to assume a position near the first opening (13) such that the pet has access to the insert (16). Thus the pet toy and feeder (10) comprises a bottom (36) comprising a non-flat surface such as to promote a side-lying orientation for the pet toy and feeder (10). In combination with the curved surface (15) of the lid (14), the pet toy and feeder (10) comprises non-flat surfaces on both ends to promote a side-lying orientation for the pet toy and feeder (10). Of course in some version the non-flat surfaces of either or both of the lid (14) and bottom (36) are not required.

In terms of positioning the pet toy and feeder (10), the ring (34) in some version is selectively positionable along the length of the main container (32) or jar (24) depending on the configuration of the pet toy and feeder (10). In some instances with this configuration the ring (34) can be positioned low near the bottom (36) and function like a kick-stand to position the pet toy and feeder (10) in a generally upright but angled position with the lid (14) at the top or upper-most point. In some instances a pet owner may desire to position the pet toy and feeder (10) in such a manner for storing, setting up, or cleaning the pet toy and feeder (10). Similarly, the ring (34) could be positioned high near the lid (14) such that the pet toy and feeder (10) could be positioned generally upright but angled in an upside-down fashion with the lid (14) at the base or lower-most point.

The insert (16) of the pet toy and feeder (10) fits loosely into the main container (32) or jar (24) when jar (24) is used. The insert (16) moves around the main container (32) or jar (24), and collects a portion of the food item held within the main container (32) or jar (24) on the outer surface of the insert (16). By way of example and not limitation, the main container (32) or jar (24) can contain peanut butter that adheres to the inner walls of the main container (32) or jar (24) when jar (24) is used. The insert (16) moves around within the main container (32) or jar (24) and collects peanut butter off the inner walls. As the insert (16) is positioned near the first opening (13) and/or the one or more second openings (12) of the lid (14) the pet has access to the insert (16), and the insert (16) can be licked through the these openings in the lid (14).

In the present example the insert (16) is spherical shaped with a diameter at its largest point of about 2.25 inches. The size of the insert (16) may be larger or smaller in other versions. Also the shape of the insert (16) may be shapes other than spherical in other versions, e.g. cube-shaped, rod-shaped, star-shaped, bone-shaped, among others that will be apparent to those of ordinary skill in the art in view of the teachings herein. Also in the present example, the insert (16) is edible such that the pet is safe to lick and eat the insert (16). In other versions, the insert (16) does not have to be edible. In some instances no separate food item is used with the pet toy and feeder (10), such that where the insert (16) is edible it is the sole food associated with the pet toy and feeder (10). In other instances no separate food item is used with the pet toy and feeder (10) and even the insert (16) is not edible such that the pet toy and feeder (10) is usable a solely a toy.

In the example where the first opening (13) of the lid (14) is about 2.3 inches and the insert (16) is about 2.25 inches, it should be noted that in some instances the insert (16) can have a smaller size than the first opening (13), or even the same size. In the present example, the insert (16) and the first opening (13) are very similarly sized such that it is possible for the insert (16) to pass through the first opening (13) such that the pet can retrieve the insert (16) unobstructed from the rest of the pet toy and feeder (10). However with the sizes of the insert (16) and the first opening (13) so similar, it remains challenging for the pet to align the insert (16) accurately enough with the first opening (13) for the insert (16) to fully pass through the first opening (13). This can extend the playtime experience for the pet such that the pet remains interested in the pet toy and feeder (10).

Referring now more specifically to FIGS. 3 and 4, in FIG. 3 a configuration for the pet toy and feeder (10) is shown where the jar (24) is used in addition to the main container (32). In this configuration the jar (24), e.g. a used substantially empty peanut butter jar without its original lid, is placed within the main container (32) with its opening facing a top (28) of the main container (32). The main container (32) thus holds and protects the jar (24). The insert (16) is placed within the jar (24), and the lid (14) connects with the main container (32) thereby holding the components of the pet toy and feeder (10) together in an assembled state. The ring (34) connects with the main container (32), wrapping around the outer wall of the main container (32). While in the present example the jar (24) is described as a peanut butter jar, in other versions different jar types can be used, e.g. an applesauce jar and other jars that will be apparent to one of ordinary skill in the art in view of the teachings herein.

In FIG. 4 a configuration for the pet toy and feeder (10) is shown where the jar (24) is used instead of the main container (32). In this configuration the jar (24), e.g. a used substantially empty peanut butter jar without its original lid, holds the insert (16), and the lid (14) connects with the jar (24) thereby holding the components of the pet toy and feeder (10) together in an assembled state. The ring (34) connects with the jar (24), wrapping around the outer wall of the jar (24). While in the present example the jar (24) is described as a peanut butter jar, in other versions different jar types can be used, e.g. an applesauce jar and other jars that will be apparent to one of ordinary skill in the art in view of the teachings herein. In this version the jar (24) comprises a top edge (22) that makes a smooth connection to the lid (14) when the lid (14) is connected with the jar (24), although such a smooth connection is not required in all versions.

As already stated with respect to the configuration of FIG. 1, the use of the jar (24) is not required and in such versions the main container (32) can hold the insert (16). Peanut butter or another food item can be placed directly inside the main container (32). In the present example the main container (32) is cylindrical in shape, with a rounded or curved bottom (36) as described above. In other versions, other shapes for the main container (32) can be used, and such other shapes will be apparent to one of ordinary skill in the art in view of the teachings herein. The main container (32) comprises the top (28), which is where the main container (32) connects and attaches tightly to the lid (14). In this version the main container (32) comprises a top edge (30) that makes a smooth connection to the lid (14) when the lid (14) is connected with the main container (32).

As described above, the ring (34) around the bottom of the main container (32) helps to move the insert (16) towards the first opening (13) and third opening (11) by lifting up the one side of the main container (32) when the pet toy and feeder (10) is lying on its side as shown in FIG. 2. In another version the ring (34) can be an additional piece placed around the bottom of the jar (24) as mentioned. In the illustrated versions the shape of the ring (34) is circular, but other shapes for the ring (34) can be used to raise the one side of the main container (32) or jar (24), and such other shapes will be apparent to one of ordinary skill in the art in view of the teachings herein. In some versions the ring (34) is constructed from a resilient material such that the ring (34) can stretch and retract to fit around various sized main containers (32) or jars (24). In such versions, the ring (34) may be one shape when not attached with the main container (32) or jar (24), and then when the ring (34) is attached with the main container (32) or jar (24) the ring (34) adopts a shape that matches the cross-sectional profile of the main container (32) or jar (24).

In the present examples, the interior and exterior walls of the main container (32) and/or jar (24) are smooth. However, in other versions the interior and/or exterior walls of the main container (32) and/or jar (24) can include texture and such texture configurations will be apparent to those of ordinary skill in the art in view of the teachings herein. Also in the present example there is a consistent wall thickness along the length of the main container (32), but this is not required in all versions. Other suitable wall thicknesses can be used in each region of the pet toy and feeder (10) as will be apparent to those of ordinary skill in the art in view of the teachings herein. For instance the wall thickness of the lid (14) and/or main container (32) can be adapted to provide a desired degree or amount of rigidity, or to direct or bias the contents held within the pet toy and feeder (10). Similarly the material construction can be used to control or provide a desired degree or amount of rigidity of the components of the pet toy and feeder (10). In one example of the main container (32) the diameter can range between from about 3.5 inches to about 8 inches and the main container (32) can have a height range between from about 4 inches to about 10 inches. These dimensions are not required in all versions.

The pet toy and feeder (10), in the present example, is constructed of thermoplastic elastomer. The thermoplastic elastomer provides a durable tear resistant and resilient material. Other suitable materials for the construction of the pet toy and feeder (10) that provide suitable resiliency and durability will be apparent to one of ordinary skill in the art in view of the teaching herein, and may include various rubbers, plastics, and polymeric materials. In the present example, the material used for constructing the pet toy and feeder (10) is also dyed to an attractive color and can be infused with a scent. For instance, in one version, the pet toy and feeder (10) is lime green in color with a vanilla scent. Other colors and/or scents that can be used and will be apparent to one of ordinary skill in the art in view of the teachings herein.

In an exemplary use of the pet toy and feeder (10), the insert (16) is placed into the interior space (18) of a used jar (24) such as a used peanut butter jar, the jar (24) is placed within the interior space (26) of the main container (32), and the lid (14) is tightly secured onto the main container (32). In the present example, the lid (14) is sized to fit the main container (32), and the jar (24) fits entirely within the interior space (26) of the main container (32). With this configuration, the pet toy and feeder (10) provides the ability to be played with, and provide an edible food or treat to the pet when the insert (16) is moved to the first opening (13), e.g. by a dog or other pet moving the pet toy and feeder (10). The durable and resilient features, as well as configuration, of the pet toy and feeder (10) protect a lip (20) of the jar (24) and the jar (24) itself from repeated chewing and licking by the pet. In this exemplary use the insert (16) is edible such that if the insert (16) is licked enough by the pet the insert (16) will reduce in size and can fall out of the pet toy and feeder (10) to be consumed by the dog or other pet.

In another exemplary use of the pet toy and feeder (10), the insert (16) is placed into a jar (24), e.g. a used peanut butter jar, and the lid (14) is tightly secured onto the jar (24). The pet toy and feeder (10) lid (14) is sized to fit a typical size peanut butter jar, or thereabouts.

In yet another exemplary use of the pet toy and feeder (10), the pet toy and feeder (10) can have a squeaker or rattle on the lid (14) or main container (32). In this example, the pet toy and feeder (10) can serve as a throw and fetch toy, or as a general chew or licking toy. Furthermore, the pet toy and feeder (10) is constructed and designed such that it floats when used in a water environment. In view of the teachings herein, other uses for the pet toy and feeder (10) will be apparent to one of ordinary skill in the art.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An apparatus for use as a pet toy and feeder comprising:
(a) a first container comprising a first opening and a first interior space;
(b) a lid configured to selectively connect to the first container, wherein the lid comprises a second opening at least partially aligned with the first opening to provide access through the second opening and the first opening to the first interior space of the first container; and
(c) an insert selectively retainable within the apparatus by the connection of the lid with the first container.

2. The apparatus of claim 1 wherein a first portion of the insert is accessible through the second opening while a second portion of the insert remains within the first interior space of the first container.

3. The apparatus of claim 1 wherein the first opening comprises a first diameter, wherein the second opening comprises a second diameter, and wherein the insert and the first and second diameters are sized such that the insert is fully passable through the first opening yet only partially passable through the second opening.

4. The apparatus of claim 3 wherein the insert comprises a spherical shape having a third diameter, wherein third diameter is smaller than the first diameter of the first opening and larger than the second diameter of the second opening.

5. The apparatus of claim 1 wherein the insert is edible.

6. The apparatus of claim 1 wherein the lid comprises a third opening configured to fit around the first opening of the first container to selectively secure the lid to the first container.

7. The apparatus of claim 6 wherein the lid threadably engages the first container.

8. The apparatus of claim 1 wherein the lid comprises a curved top surface, wherein the curved top surface extends around the second opening in the lid.

9. The apparatus of claim 8 wherein the lid comprises a fourth opening within the curved top surface of the lid, wherein the fourth opening provides access to the first interior space of the first container.

10. The apparatus of claim 1 wherein the container comprises a peanut butter jar.

11. The apparatus of claim 1 comprising a projecting member configured to extend from an outside wall of the first container.

12. The apparatus of claim 11 wherein the projecting member comprises a ring that selectively connects with and extends around the outside wall of the first container.

13. The apparatus of claim 12 wherein a position of the ring can be adjusted along a length of the first container.

14. The apparatus of claim 1 wherein the first container comprises a bottom comprising a non-flat surface.

15. The apparatus of claim 14 wherein the bottom is rounded.

16. The apparatus of claim 1 wherein the first container is configured to contain a food item.

17. The apparatus of claim 16 wherein the insert is positionable within the first container and moves freely within the first interior space of the first container to collect a portion of the food item on a surface of the insert.

18. The apparatus of claim 1 comprising a second container, wherein the second container comprises a second interior space and is positionable within the first interior space of the first container, and wherein the insert is positionable within the second interior space of the second container.

19. The apparatus of 18 wherein the second container is configured to contain a food item, wherein the insert moves freely within the second interior space of the second container to collect a portion of the food item on a surface of the insert.

20. An apparatus for use as a pet toy and feeder comprising:
(a) a container configured to retain a food item, the container comprising:
(i) a first opening,
(ii) a bottom opposite the first opening and comprising a non-flat surface,
(iii) an interior space, and
(iv) a guiding feature;
(b) a lid configured to selectively connect to the container, wherein the lid comprises:
(i) a second opening at least partially aligned with the first opening to provide access through the second opening and the first opening to the interior space of the container, and
(ii) a curved top surface, wherein the curved top surface extends around the second opening in the lid; and
(c) an insert selectively retainable within the container by the connection of the lid with the container,
(i) wherein the insert is biased to a position within the container toward the first opening of the container by the guiding feature of the container, and
(ii) wherein a first portion of the insert is accessible through the second opening while a second portion of the insert remains within a select one of the interior space of the container and an inner space defined by the lid.
